(19) United States
(12) Patent Application Publication
(10) Pub. No.: US 2024/0042814 A1
(43) Pub. Date: Feb. 8, 2024

(54) TRAILER COUPLER

(71) Applicant: Pacific Rim International, LLC, Vancouver, WA (US)

(72) Inventor: Todd Walstrom, Tomahawk, WI (US)

(73) Assignee: Pacific Rim International, LLC, Vancouver, WA (US)

(21) Appl. No.: 17/880,517

(22) Filed: Aug. 3, 2022

(51) Int. Cl. B60D 1/06; B60D 1/28

(52) U.S. Cl. CPC B60D 1/065; B60D 1/28

(57) ABSTRACT

A coupler is provided for attachment to a trailer and for receiving and selectively locking onto a hitch ball of a towing vehicle. The coupler may include a coupler body to attach to the trailer. The coupler body may have a socket attached to the upper surface of the coupler body adjacent. A socket and an adjacent clamp may be provided for selectively locking onto the hitch ball. A handle may be disposed above the upper surface of the coupler body and operatively coupled to the clamp for selectively moving the clamp between a locked position and an unlocked position. The handle may be rotatable about an axis that is substantially perpendicular to the upper surface of the coupler body. The handle may be connected to the clamp by a rod defining a long axis. The rod may include a pin that rides on a pair of ramped surfaces to convert a rotational movement of the handle to translational movement of the clamp between a locked position and an unlocked position.

### BACKGROUND

This disclosure relates in general to a device and components for use as a trailer coupler. The trailer coupler is particularly suited to connecting to a hitch ball on a towing vehicle and the structure may also be used in other types of couplers. More specifically, this disclosure relates to devices and components for clamping onto the hitch ball and a user-operated handle for setting and controlling the clamping and unclamping of the coupler onto the hitch ball, including the capability for the handle to hold the coupler in an unlocked condition and to provide a secondary locking feature.

Ball clamp couplers typically have a downwardly-opening cavity to receive the hitch ball of a towing vehicle. The reception of the ball in the cavity generally occurs in a vertical direction, i.e., perpendicular to the ground. A channel adjacent to the cavity, and typically oriented at an angle of about 20-25° from vertical, provides space for a clamp to be moved downward in the channel to affix the coupler to the ball and to be moved upward to release the ball. These couplers typically include a flip-up trigger switch for moving the clamp, which has various drawbacks addressed by embodiments of the present disclosure. Trailer couplers of the ball clamp type are shown in U.S. Pat. Nos. 7,690,673 and 6,505,849, which are hereby incorporated by reference for all purposes.

### SUMMARY

According to an aspect of the present disclosure, a device may include a coupler configured for attachment to a trailer and for receiving and selectively locking onto a hitch ball of a towing vehicle. The coupler may include a coupler body configured to be attached to the trailer and the coupler body may define an upper surface. A socket may be attached to the coupler body adjacent the upper surface and the socket may be configured to receive the hitch ball. A clamp may be disposed adjacent the socket and configured to cooperate with the socket for selectively locking onto the hitch ball. A handle may be disposed above the upper surface of the coupler body, operatively coupled to the clamp for selectively moving the clamp between a locked position and an unlocked position. The handle may be rotatable about an axis that is substantially perpendicular to the upper surface of the coupler body. The coupler may further include a stop disposed in a channel adjacent the lower opening of the cavity, and the stop may be operative to prevent the clamp from moving beyond the lower opening. The coupler may include a rod connecting the handle to the clamp, wherein the rod rotates about its long axis and/or relative to the clamp during movement between the locked position and the unlocked position. The coupler may include a curved ramped surface on the upper surface of the coupler body cooperating with the handle to move the clamp between the locked position and the unlocked position. The handle of the coupler may further include a pair of curved channels for receiving the ramped surfaces when the handle is rotated so as to move the clamp to the unlocked position. The rod may further include an opening perpendicular to the long axis of the rod and may further include a pin inserted through the rod opening wherein the pin rides on the ramped surfaces during movement between the locked position and the unlocked position. At least one of the ramped surfaces may include a detent to receive and hold the pin with the clamp in the open position. The coupler may further include a pair of tabs, one affixed to the handle and one affixed to the coupler body, the tabs each including an opening, wherein the openings are aligned with one another when the clamp is in the locked position, the aligned openings operative for insertion of a padlock shaft therethrough.

Another device may include a coupler configured for attachment to a trailer and for receiving and selectively locking onto a hitch ball of a towing vehicle. The coupler may include a coupler body configured to be attached to the trailer, the coupler body defining an upper surface and at least one ramped surface extending upward from the upper surface. The coupler may include a socket attached to the coupler body adjacent the upper surface, the socket configured to receive the hitch ball. The coupler may further include a clamp disposed adjacent the socket, the clamp configured to cooperate with the socket for selectively locking onto the hitch ball. The coupler may further include a handle disposed above the upper surface of the coupler body, the handle operatively coupled to the clamp for selectively moving the clamp between a locked position and an unlocked position, and wherein the handle includes a skid that rides on the ramped surface during movement between the locked position and the unlocked position. The handle may be rotatable about an axis that is substantially perpendicular to the upper surface of the coupler body. The ramped surface may be one of a pair of curved ramped surface, and the skid may be one of a pair of skids, each of the skids configured to ride on the ramped surface during movement between the locked position and the unlocked position. The pair of curved ramp surfaces may be substantially semicircular. The coupler may include a rod connecting the handle to the clamp, the rod defining a long axis, and wherein the rod rotates about its long axis relative to the clamp during movement between the locked position and the unlocked position.

A trailer may include a coupler for receiving and selectively locking onto a hitch ball of a towing vehicle. The coupler may include a socket configured to receive the hitch ball, an upper surface adjacent the socket, and at least one ramped surface extending upward from the upper surface. A clamp may be disposed adjacent the socket, configured to cooperate with the socket for selectively locking onto the hitch ball. The coupler may further include a handle disposed above the upper surface of the coupler body, the handle operatively coupled to the clamp for selectively moving the clamp between a locked position and an unlocked position. The handle may be rotatable about an axis that is substantially perpendicular to the upper surface of the coupler body. The handle may include a skid that rides on the ramped surface during movement between the locked position and the unlocked position. The ramped surface may be one of a pair of curved ramped surfaces, and the skid may be one of a pair of skids, each of the skids configured to ride on the ramped surface during movement between the locked position and the unlocked position.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 shows an example of a coupler attached to a trailer (partially shown), according to exemplary embodiments of the present disclosure, and also showing a hitch ball coupled to a towing vehicle (partially shown), with the hitch ball in a socket of the coupler, and a handle on the coupler in a locked position wherein the coupler cannot be removed from the hitch ball.

FIG. 2 shows the coupler of FIG. 1, without the trailer, and showing the handle in an unlocked position wherein the coupler can be removed from the hitch ball.

FIG. 3 is a side view of a coupler, similar to that of FIGS. 1-2, in this case with an alternate means for attaching to the trailer, in this case a flat plate.

FIG. 4 is a perspective view of the coupler of FIG. 3, showing bolt holes for the flat plate attachment with the trailer.

FIG. 5 shows a cross-section of the coupler as in FIG. 1 with the handle in the locked position, and showing the ball within the socket and a clamp that is fixing the ball in place in the socket, the clamp in turn being fixed in place by a rod connected to the handle.

FIG. 6 shows the cross-section of the coupler as in FIG. 5, but now with the handle and the clamp in the unlocked position, wherein rotation of the handle has caused the handle, the rod and the clamp to move upwardly along a slanted channel in the coupler body, with the clamp in this position allowing the coupler to be removed from the hitch ball of the towing vehicle.

FIG. 7 is a perspective view of the handle as shown in the preceding figures, illustrating the instructional indicia on an upper side of the handle indicating how to position the handle to the locking position and showing a rear tab providing a secondary locking feature in cooperation with a tab (see FIG. 8) on an upper surface of the coupler body.

FIG. 8 is a cross-sectional view of a coupler body without the handle, rod, or clamp installed, showing the socket for the hitch ball, a lower opening from the socket to a channel that extends up to an upper opening through an upper surface of the coupler body, and showing a semicircularly curved, ramped surface extending up from the upper surface, and also showing one of a pair of raised bosses within the channel, each boss further defining a groove for constraining the movement of the clamp.

FIG. 9 is a perspective view of the clamp as in FIGS. 5-6, showing a ball-clamping surface, a bolt hole for coupling to the rod, one of a pair of side ridges that ride in the grooves in the channel defined by bosses of the coupler body.

FIG. 10 is a pin that is inserted through a transverse hole in the rod (see FIG. 11) and with ends that act as a pair of skids, during rotation of the handle from the locked position to the unlocked position, the skids riding on the ramped surfaces of the coupler body, and also showing the pin includes lengthwise grooves along a central, expanded-diameter portion of the pin to aid in the press-fitting of the pin in the transverse hole of the rod.

FIG. 11 is a rod that is bolted at a lower end to the clamp and at an upper end to the handle to couple the movement of the handle to the movement of the clamp.

FIG. 12 is a side view of the handle, showing, in addition to the secondary-locking tab, an abutment which, in rotation to the unlocked position, abuts one of the curved ramp surface to constrain the rotation of the handle.

FIG. 13 is an overhead view of the handle as in preceding figures, further illustrating the tab and the abutment and also finger grips and the flat-sided hole to receive a flat-sided portion of the rod in a non-rotatable manner, and also illustrating the cut for the cross-section of FIG. 14.

FIG. 14 is a cross-section view of the handle of FIG. 13, showing the internal channels that receive the ramped surfaces of the coupler body when the handle is in the locked position.

FIG. 15 is a rear view of the coupler body without the handle, rod, or clamp, as in FIG. 8, and showing the semi-circular shape of the curved ramp surfaces.

FIG. 16 is a close-up cross-section of the coupler of the preceding figures, in this case showing the handle bolted to the rod at the upper end of the rod, and showing the handle and rod in the locked position.

FIG. 17 is a close-up cross-section of the coupler of the preceding figures, in this case showing the clamp bolted to the rod at the lower end of the rod, and showing the clamp and rod in the locked position.

FIG. 18 is a cross-section of the coupler similar to that of the preceding figures, in this case with an alternate embodiment for the handle, the ramped surface, and the secondary locking feature.

FIG. 19 is an overhead view of the coupler of FIG. 18 with the handle removed and with only a single curved ramped surface subtending an arc of about 90° and the secondary locking figure adjacent the bottom of the ramped surface.

FIG. 20 is a rear elevation of the secondary locking feature of FIGS. 18 and 19, showing a slot for receiving a portion of the handle and a bump for holding the handle in place in the slot.

In the appended figures, similar components and/or features may have the same reference number or the same number with a letter suffix.

### DETAILED DESCRIPTION

The following detailed description of some exemplary embodiments of the present disclosure do not limit the scope, applicability, or configuration of the other embodiments that will be understood from the present disclosure. The ensuing description will provide those skilled in the art with an enabling description not only for the exemplary embodiment but also other embodiments within the scope of the present disclosure. It is understood that various changes may be made in the function and arrangement of elements without departing from the spirit and scope as set implementing forth in the appended claims.

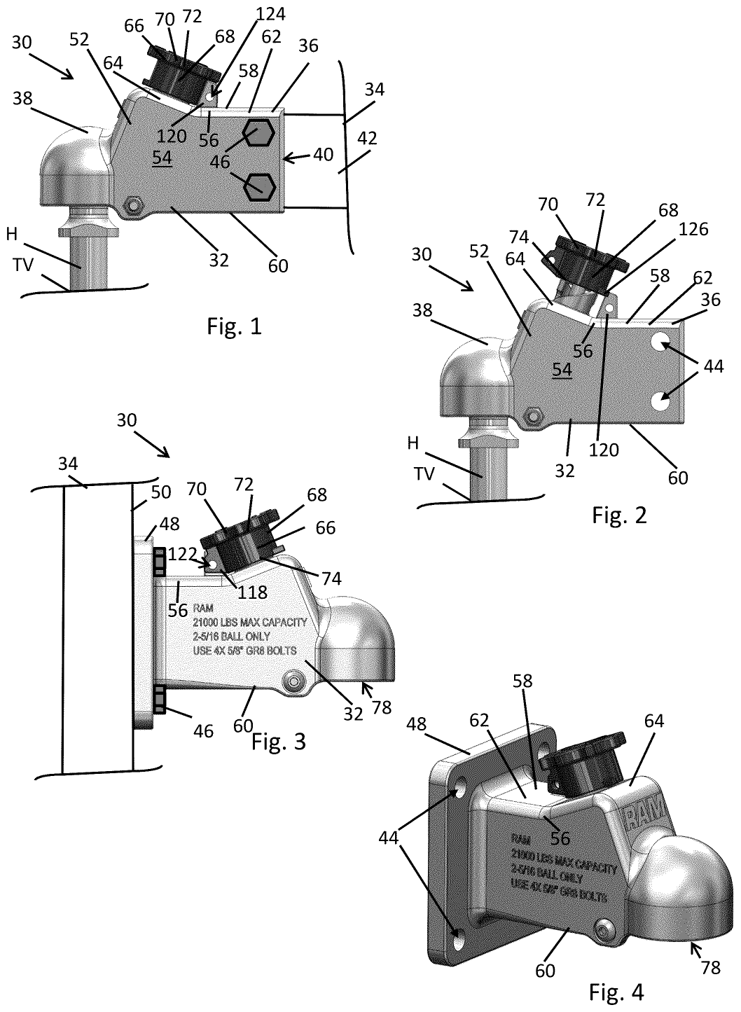

As shown in FIGS. 1-6, a coupler 30 may include a coupler body 32 for use with a trailer 34. Generally, coupler body 32 includes a rear portion 36 where it may be attached to trailer 34, and a forward portion 38 where it may be coupled to a towing vehicle TV at a hitch H, e.g., at a hitch ball HB.

Trailer 34 may be of any type and coupler body 32 may be provided with a suitable configuration for attachment to the particular trailer type. For example, FIGS. 1-2 depict a coupler with a channel mount configuration and FIGS. 3-4 depict a coupler with a flat mount configuration, each suited for mounting and attaching to a corresponding structure on trailer 34. It will be understood that the couplers in the flat mount and channel mount configurations are substantially similar in structure except for the manner of mounting to the trailer.

In the channel mount configuration, rear portion 36 includes a channel 40 configured to receive an end portion of a bar or beam 42 of trailer 34, and an attachment mechanism, such as bolt holes 44 that may be securely affixed by any suitable means, such as with bolts 46 to trailer 34. In the flat mount configuration, rear portion 36 includes a plate 48 configured to be attached to a flat structure 50 of trailer 34 and to be securely affixed by any suitable means, such as with bolts 46 to trailer 34. It will be understood that various combinations of the channel and flat-plate structure or other attachment structure may be provided on the coupler as suited for attachment and use with trailer 34.

Typically, coupler body 32 defines a roughly rectangular housing 52 with two side walls 54, a top wall 56 defining an upper surface 58, and a bottom wall 60. In ordinary operation, bottom wall 60 is roughly parallel to the ground when coupler 30 is attached to trailer TV. Upper surface 58 may include a portion 62 that is roughly parallel to bottom wall 60 and a portion 64 that is angled relative to bottom wall 60.

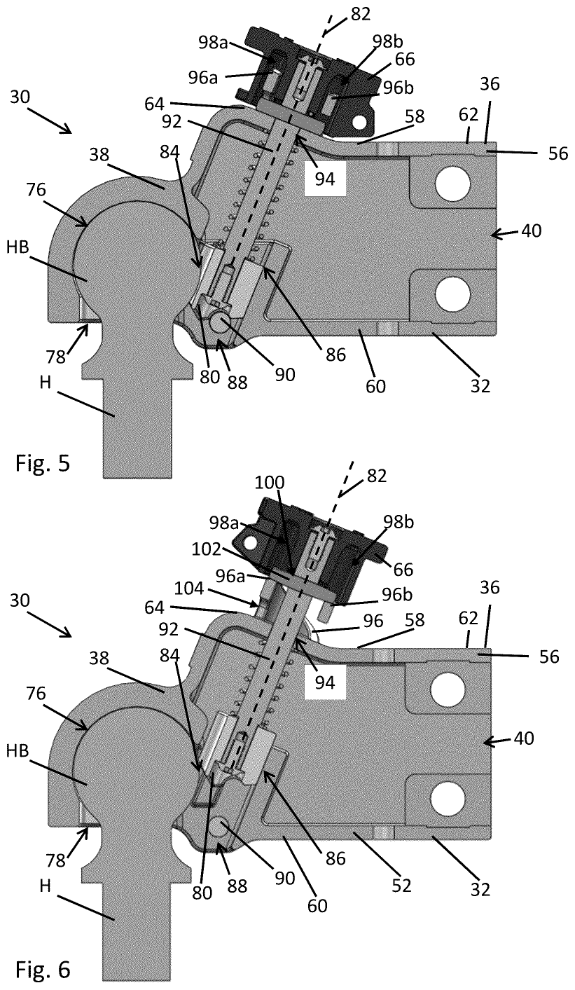

A handle 66 may be disposed above upper surface 58, such as a roughly cylindrical knob 68 with finger grips 70 at an upper end 72. A lower end 74 of handle 66 may be substantially flush with upper surface 58 in the locked position (FIGS. 1 and 5) and raised away from upper surface 58 in the unlocked position (FIGS. 2 and 6).

A socket 76 may be attached to coupler body 32, for example by being formed integrally with coupler body by any suitable means such as casting and/or machining. Socket 76 is typically adjacent to upper surface 58 and may be configured to receive hitch ball HB though an opening 78, which is typically adjacent, and may be substantially level with, bottom wall 60. A clamp 80 may be disposed adjacent to socket 76. Clamp 80 may be configured to cooperate with 76 socket for selectively locking onto hitch ball HB. FIG. 5 shows socket 76 and clamp 80 locked onto hitch ball HB and FIG. 6 shows socket 76 and clamp 80 unlocked from hitch ball HB.

Handle 66 may be operatively coupled to clamp 80 for selectively moving clamp 80 between a locked position (FIG. 5) and an unlocked position (FIG. 6). Handle 66 may be rotatable about an axis 82 that may be substantially perpendicular to upper surface 58 of coupler body 32. For example, axis 82 may be substantially perpendicular to angled portion 64 of upper surface 58 of coupler body 32. Handle 66 may be rotated about axis 82 to move clamp 80 between the locked and unlocked positions.

Coupler body 32 may be built using any suitable construction materials and methods, such as cast steel, cast iron, or stamped steel plate, or other materials and methods commonly used for trailer couplers to provide sufficient strength for a secure coupling between the trailer and the towing vehicle during a towing operation.

Socket 76 typically includes a side opening 84 into which clamp 80 may move for the selective locking of hitch ball HB. Socket 76 may further include a channel 86 adjacent side opening 84. Channel 86 may define a lower opening 88 and clamp 80 may be movable within channel 86 for the selective movement between the locked position and the unlocked position. Socket 76 may also include a stop 90 disposed in channel 86 adjacent lower opening 88. Stop 90 may be operative to prevent clamp 80 from moving beyond lower opening 88.

A connector, such as a rod 92, may couple handle 66 to clamp 80. Rod 92 may define and rotate about a long axis coincident with axis 82 about which handle 66 may rotate. Rod 92 typically moves along its long axis during movement between the locked position and the unlocked position. Typically rod 92 is fixed to handle 66 so that rod 92 rotates about its long axis as handle 66 and rod 92 move between the locked and the unlocked positions. Rod 92 may rotate relative to clamp 80 during movement between the locked position and the unlocked position, in which case clamp 80 moves along channel 86 substantially without rotation.

Upper surface 58, e.g., at angled portion 64, may include an opening 94 defined through upper surface 58. Typically, rod 92 extends through opening 94 and may be coupled to clamp 80 below opening 94 and may be coupled to handle 66 above opening 94. A ramped surface 96 may be provided on upper surface 58 of coupler body 32, e.g., adjacent opening 94.

Ramped surface 96 may cooperate with handle 66 to move clamp 80 between the locked position and the unlocked position as seen in FIGS. 5 and 6. These figures also show how clamp 80 in the locked position (FIG. 5) blocks withdrawal of hitch ball HB downwardly out of socket 76, while in the unlocked position (FIG. 6) clamp 80 has moved clear of hitch ball HB to allow withdrawal of the hitch ball from socket 76.

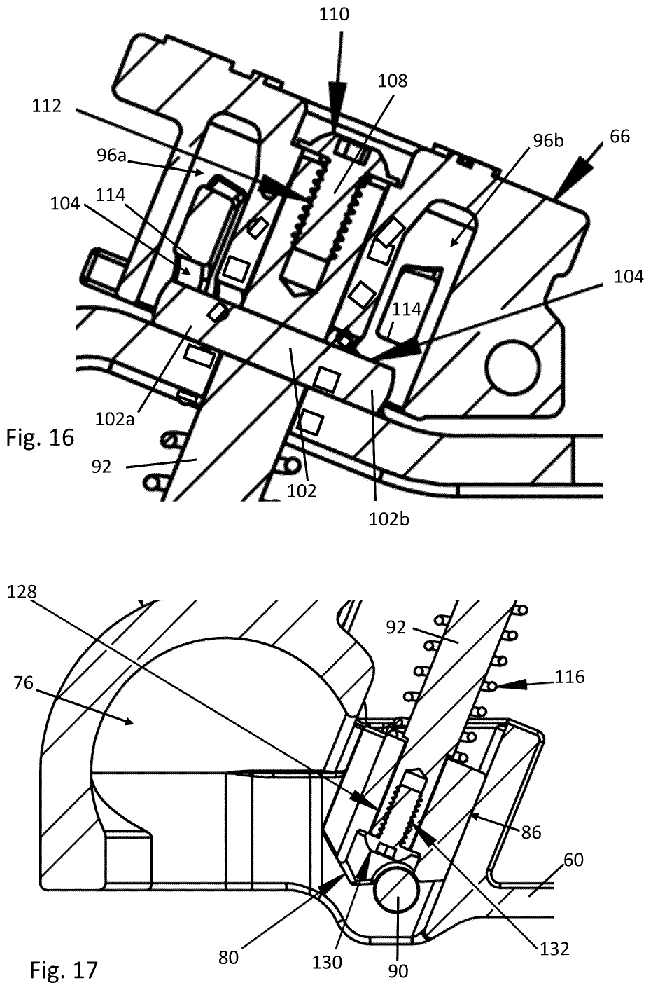

Coupler body 32 may include a pair of curved ramped surfaces 96a, 96b on upper surface 58. Curved ramped surfaces 96a, 96b may be semicircular and opening 94 may be centered relative to the curved ramp surfaces. The pair of curved ramped surfaces 96a, 96b may cooperate with handle 66 to move clamp 80 between the locked position and the unlocked position as seen in FIGS. 5 and 6. The structure of the curved ramp surfaces may be seen more clearly with reference to FIGS. 8 and 15.

Handle 66 may include a pair of curved channels 98a, 98b. Curved, ramped surfaces 96a, 96b may be received in channels 98a, 98b for installation of handle 66 to the coupler. Curved channels 98a, 98b may receive the curved surfaces to allow rotating handle 66 so as to move clamp 80 to the locked position, and the curved surfaces may be at least partially received within the channels with the clamp in the unlocked position.

Rod 92 may be connected to handle 66 by any means suitable to the particular application of the coupler. For example rod 66 may include an opening 100 (FIGS. 6 and 11), which may be substantially perpendicular to long axis 82 of rod 92. As seen in FIGS. 6 and 10, a fastener that can provide for structure that operates a pair of skids, such as a pin 102, with ends 102a, 102b, may be inserted through opening 100 in rod 92. Pin 102 may ride on ramped surfaces 96a, 96b as handle 66 is rotated about long axis 82 to convert the rotational movement to a translational movement of rod 92 along axis 82, which in turn moves clamp 80 along axis 82. Thus, rotating handle 66 provides the movement between the locked position and the unlocked position of coupler 30. Handle 66 may additionally be coupled to rod 92 by a fastener, such as a bolt 108 with a head 110 that extends along axis 82 into a threaded cavity 112 in rod 92.

As best seen in cross-section in FIG. 17, clamp 80 may be bolted to rod 92 at a lower end 128 of rod 92 by a fastener such as bolt 130 in a threaded cavity 132 in rod 92. FIG. shows clamp 80 and rod 92 moved down in channel 86 to the locked position with stop 90 preventing any further downward movement of clamp 80.

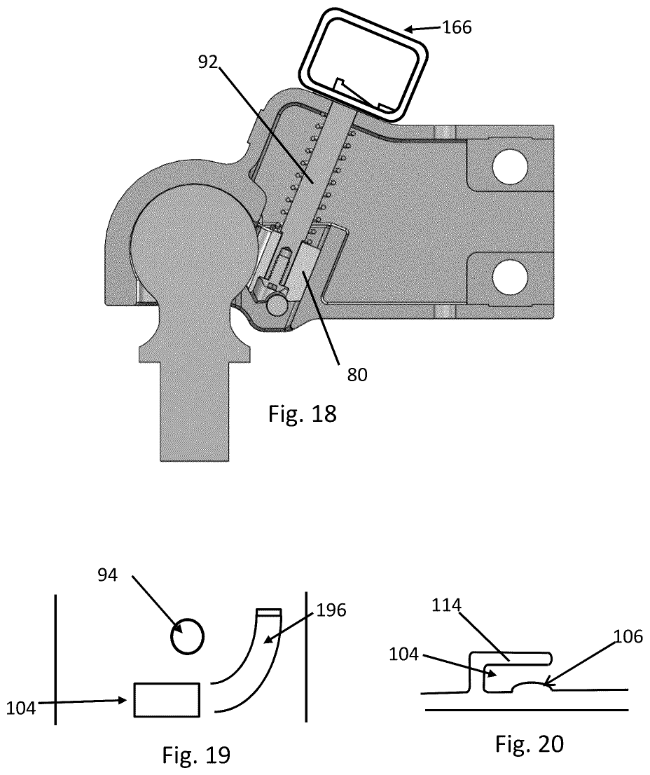

As best seen in FIGS. 8 and 16, the structure for the ramped surfaces may include for one or both structures a space 104 to receive pin 102 in the locked position. In an alternative embodiment shown in FIGS. 18-20, space 104 may include a detent 106 (see FIG. 20) adjacent to space 104. Detent 106 may be configured to hold pin 102 when pin 102 is in space 104 and clamp 80 is in the locked position. The embodiment of FIGS. 18-20 is generally similar to the other embodiments, and may include a clamp 80 capable of locking on the hitch ball, with the clamp coupled via rod 92 through opening 94 to a handle, such as D-shaped handle 166, that rides on a single ramped surface 196 between the locked position (FIG. 18) and an unlocked position with clamp 80 withdrawn up the channel away from the hitch ball.

Spaces 104 each include an upper edge 114 (FIGS. 16 and 20) that prevents upward movement of pin 102 and this also prevents upward movement of handle 66 and of rod 92 along axis 82. Typically, space 104 and upper edge 114 provide a slot that is integral to the ramped surfaces, as in FIG. 16, or the slot may be provided separately, as in FIG. 20.

Upper edge 114 thus prevents clamp 80 from moving out of the locking position except for the case where the handle is rotated by a user from the locked position to the unlocked position. This provides a secondary locking feature that retains the clamp and the handle in the locked position even if an upward force is applied to clamp 80, as may happen in some undesired operating conditions.

A spring 116 may be provided to bias rod 92 and clamp 80 toward the locked position. For example, spring 116 may be provided around rod 92 with an upper end against an inner ceiling of housing 52 and a lower end against clamp 80. Spring 116 also biases pin 102 against the outer slanted surface 64 of housing 52. An undesired upward force on clamp 80 can compress the spring and move pin 102 upward but the clamp will be prevented from moving out of the locked position by upper edge 114, as described above.

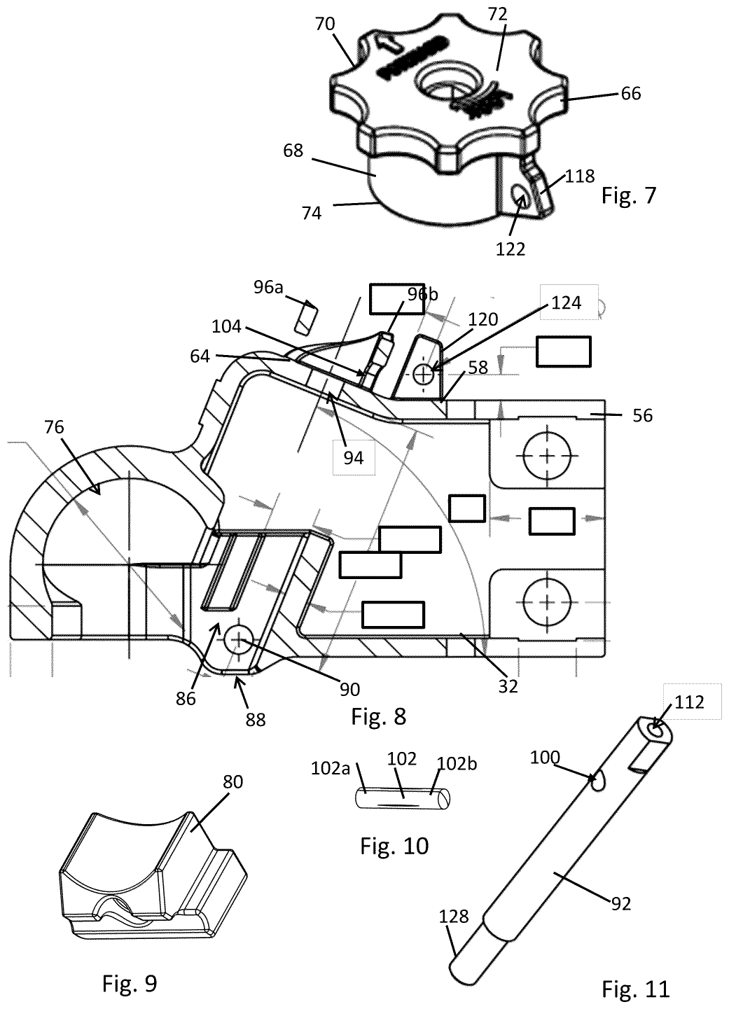

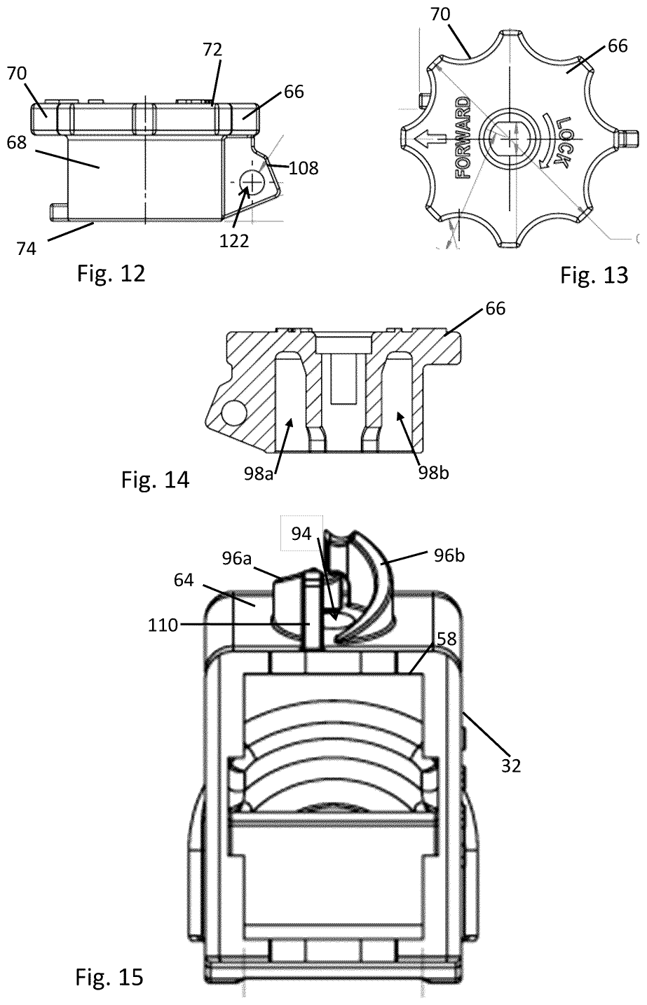

As shown, e.g. in FIGS. 1-3 and 7-8, coupler 30 may include a pair of tabs 118, 120, one affixed to, or provided integrally with, handle 66 and one affixed to, or provided integrally with, coupler body 32. Tabs 118, 120 may each provide an opening 122, 124 that may be aligned with one another when clamp 80 is in the locked position. Openings 122, 124, when aligned, may be operative for insertion of a padlock shaft therethrough to secure the coupler in the locked position. As shown in FIG. 2, handle 66 may have a second tab 126, opposite tab 118, that in rotating the handle to the unlocked position comes into contact with tab 120 on housing 52 to prevent over rotation of the handle when in the unlocked position.

Specific details are given in the above description to provide a thorough understanding of the embodiments. However, it is understood that the embodiments may be practiced without these specific details. For example, structures may be shown in simplified diagrams in order not to obscure the embodiments in any detail. In other instances, well-known processes, structures, and techniques may be shown without unnecessary detail in order to avoid obscuring the embodiments.

While the principles of the disclosure have been described above in connection with specific apparatuses and methods, it is to be clearly understood that this description is made only by way of example and not as limitation on the scope of the disclosure.

What is claimed is:

1. A coupler for use with a trailer, the coupler configured for attachment to the trailer and for receiving and selectively locking onto a hitch ball of a towing vehicle, the coupler comprising:
a. a coupler body configured to be attached to the trailer, the coupler body defining an upper surface;
b. a socket attached to the coupler body adjacent the upper surface, the socket configured to receive the hitch ball;
c. a clamp disposed adjacent to the socket, the clamp configured to cooperate with the socket for selectively locking onto the hitch ball; and
d. a handle disposed above the upper surface of the coupler body, the handle operatively coupled to the clamp for selectively moving the clamp between a locked position and an unlocked position, wherein the handle is rotatable about an axis that is substantially perpendicular to the upper surface of the coupler body.

2. The coupler of claim 1 wherein the socket further includes a side opening into which the clamp moves for the selective locking of the hitch ball and a channel adjacent the side opening, the channel defining a lower opening, wherein the clamp is movable within the channel for the selective movement between the locked position and the unlocked position, and further including a stop disposed in the channel adjacent the lower opening, the stop operative to prevent the clamp from moving beyond the lower opening.

3. The coupler of claim 1 wherein a rod connects the handle to the clamp, the rod defining a long axis, and wherein the rod rotates about its long axis during movement between the locked position and the unlocked position.

4. The coupler of claim 3 wherein the rod rotates relative to the clamp during movement between the locked position and the unlocked position.

5. The coupler of claim 3 wherein the upper surface includes an opening defined therethrough, and the rod extends through the opening.

6. The coupler of claim 4 wherein the rod is coupled to the clamp below the opening and coupled to the handle above the opening.

7. The coupler of claim 5 further including a ramped surface on the upper surface of the coupler body, the ramped surface cooperating with the handle to move the clamp between the locked position and the unlocked position.

8. The coupler of claim 5 further including a pair of curved ramped surfaces on the upper surface of the coupler body, the ramped surfaces cooperating with the handle to move the clamp between the locked position and the unlocked position.

9. The coupler of claim 8 wherein the handle includes a pair of curved channels and wherein the ramped surfaces are received in the channels when the handle is rotated so as to move the clamp to the locked position.

10. The coupler of claim 8 wherein the rod further includes an opening perpendicular to the long axis of the rod and further including a pin inserted through the rod opening and wherein the pin rides on the ramped surfaces during movement between the locked position and the unlocked position.

11. The coupler of claim 10 wherein at least one of the ramped surfaces includes a detent to receive and hold the pin with the clamp in the open position.

12. The coupler of claim 1 further including a pair of tabs, one affixed to the handle and one affixed to the coupler body, the tabs each including an opening, wherein the openings are aligned with one another when the clamp is in the locked position, the aligned openings operative for insertion of a padlock shaft therethrough.

13. A coupler for use with a trailer, the coupler configured for attachment to the trailer and for receiving and selectively locking onto a hitch ball of a towing vehicle, the coupler comprising:
a. a coupler body configured to be attached to the trailer, the coupler body defining an upper surface and at least one ramped surface extending upward from the upper surface;
b. a socket attached to the coupler body adjacent the upper surface, the socket configured to receive the hitch ball;
c. a clamp disposed adjacent the socket, the clamp configured to cooperate with the socket for selectively locking onto the hitch ball; and
d. a handle disposed above the upper surface of the coupler body, the handle operatively coupled to the clamp for selectively moving the clamp between a locked position and an unlocked position, and wherein the handle includes a skid that rides on the ramped surface during movement between the locked position and the unlocked position.

14. The coupler of claim 13 further wherein the handle is rotatable about an axis that is substantially perpendicular to the upper surface of the coupler body.

15. The coupler of claim 14 further wherein the ramped surface is one of a pair of curved ramped surface, and the skid is one of a pair of skids, each of the skids configured to ride on the ramped surface during movement between the locked position and the unlocked position.

16. The coupler of claim 15 wherein a rod connects the handle to the clamp, the rod defining a long axis, and wherein the rod rotates about its long axis relative to the clamp during movement between the locked position and the unlocked position.

17. The coupler of claim 16 wherein the upper surface includes an opening defined therethrough, and the rod extends through the opening.

18. The coupler of claim 17 wherein the pair of curved ramp surfaces are substantially semicircular, and further wherein the opening is centered relative to the curved ramp surfaces.

19. A trailer including a coupler for receiving and selectively locking onto a hitch ball of a towing vehicle, wherein the coupler comprises:
a. a socket configured to receive the hitch ball;
b. an upper surface adjacent the socket and at least one ramped surface extending upward from the upper surface;
c. a clamp disposed adjacent the socket, the clamp configured to cooperate with the socket for selectively locking onto the hitch ball; and
d. a handle disposed above the upper surface of the coupler body, the handle operatively coupled to the clamp for selectively moving the clamp between a locked position and an unlocked position, wherein the handle is rotatable about an axis that is substantially perpendicular to the upper surface of the coupler body, and wherein the handle includes a skid that rides on the ramped surface during movement between the locked position and the unlocked position.

20. The trailer of claim 19 wherein the ramped surface is one of a pair of curved ramped surface, and the skid is one of a pair of skids, each of the skids configured to ride on the ramped surface during movement between the locked position and the unlocked position.
